(19) United States
(12) Patent Application Publication
(10) Pub. No.: US 2005/0106294 A1
(43) Pub. Date: May 19, 2005

(54) Water-vapour and smoke permeable food casing comprising a rough, natural surface

(76) Inventors: Stefanie Stalberg, Taunusstein-Wehen (DE); Bernhard Feron, Wiesbaden (DE); Ulrich Dleius, Frankfurt (DE); Michael Schmidt, Oestrich-Winkel (DE)

Correspondence Address: Klaus Schweitzer;ProPat, 425 C South Sharon Amity Road, North Carolina, NC, 28211, US

(21) Appl. No.: 10/503,319

(22) PCT Filed: Nov. 25, 2002
(86) PCT No.: PCT/DE02/04345

(30) Foreign Application Priority Data
Mar. 1, 2002 (DE) 102 08 858.6

(51) Int. Cl. A23G 1/00

(52) U.S. Cl. 426/135

(57) ABSTRACT

The invention relates to a food casing made of a thermoplastic blend, which comprises at least one aliphatic polyamide and/or copolyamide and/or at least one aliphatic and/or partially aromatic copolyamide containing glycol and/or polyglycol units, in addition to at least one inorganic and/or organic filler. The casing has a maximum surface roughness Rₘₐₓ of between 7 to 60 μm and a water vapor permeability of at least 50 g/m²·d. Said casing thus has a particularly matt, rough, extremely natural surface structure. The casing is produced by extrusion with the aid of an annular-shaped die and subsequent blow moulding or biaxial stretch orientation. It is suitable for use as an artificial sausage casing, in particular for raw sausage, such as salami.

The present invention relates to a food casing made of a thermoplastic mixture which comprises at least one aliphatic polyamide and/or copolyamide and/or at least one aliphatic and/or partially aromatic copolyamide containing glycol and/or polyglycol units. The invention also relates to a process for production and use thereof as artificial sausage casing.

Food casings, especially sausage casings, are produced from natural gut skin, textile, fiber or cellulose skin, collagen or plastic. The collagen or hide fiber sausage skin is distinguished by a natural surface and pleasant feel properties, is produced from cattle hides by a very complex and environmentally polluting process. The skin tissue is digested as far as the fibrils using acids (for example lactic acid); the high-viscosity mass is extruded and using gaseous ammonia or ammonium hydroxide, slowly and in a compact form precipitated and solidified. During the drying a crosslinking (curing) then takes place in order to impart sufficient stability to the products so that they withstand the scalding process without significant strength loss. Natural gut skins, such as hide fiber sausage skins, however, have increasingly less acceptance with the end consumers owing to various events, such as the BSE disease in cattle and the misuse of antibiotics. In addition, legal restrictions are threatened. An alternative to said sausage skins is therefore desirable. Cellulose skins, even those of fiber reinforcement, can take over this task only with limitations. The production process is also no less complex and environmentally polluting than the collagen process. Food casings based on synthetic polymers, in contrast, can represent a true alternative. These can be produced very simply and without hygienic defects via a combined extrusion and film-blowing process (if appropriate biaxial orientation). However, pure plastic casings, on account of their unnatural, smooth and glossy surface, have not been able to establish themselves in the market sector for collagen or natural gut skins. In addition, they can store only very little water and have only a low permeability for water vapor and smoke.

Plastic casings modified with natural substances are also known. For instance, EP-B 0 711 324 describes a reinforced biodegradable polymer which comprises thermoplastic starch, a hydrophobic biodegradable polymer and a natural fiber such as ramie or sisal. EP-A 0 596 437 reports on mixtures of starch or thermoplastic starch, for example, with aliphatic polyesters or poly(vinyl alcohol) which may be processed by thermoplastic extrusion to give water-resistant biodegradable films.

EP-B 0 539 544 discloses a polymer mixture of starch, a plasticizer and a polyolefin. A material made of one or more synthetic polymers, for example a homo- or copolymer of hydroxycarboxylic acids, polyurethanes, polyamides and vinyl alcohol copolymers and starch are described in WO 92/19680.

In most applications of this type the biodegradability plays a key Natural appearance and pleasant feel properties are of secondary importance here, the high water vapor permeability plays just as little a role.

A smoke-permeable food casing is described in EP-A 920 808. As essential constituent it comprises cellulose acetate propionate, if appropriate in a mixture with an aliphatic polyamide or copolyamide, such as polyamide 6, polyamide 6/66, polyamide 12 or polyamide 6/12. They can, in addition, comprise plasticizers, such as phthalic esters, glycol or glycerol derivatives.

EP-A 1 102 814 discloses food casings made from a thermoplastic mixture comprising a polysaccharide component and a plasticizer. The casings consist of thermoplastic starch or thermoplastic starch derivatives and a thermoplastic polyester urethane (TPU). Seamless tubular casings made of this material have low sigma 15 values of from about 3 to 4.5; that is to say they are readily deformable and therefore do not exhibit sufficient caliber constancy. The casings have a milky matt optical appearance. However, the roughness and slightly inhomogeneous structure which make up the natural feel properties of a collagen skin or natural gut skin are absent. In addition, it is disadvantageous that these casings show an undesirably high cloudiness as soon as they are enclosed by a second packaging of plastic film and as a result are exposed to high relative humidity.

EP-A 0 935 423 discloses a sausage casing based on polyamide which contains block copolymers having hard aliphatic polyamide blocks and soft aliphatic polyether blocks. The water vapor permeability of such casings is about 75 g/m²d which is too little for air-ripening uncooked sausage varieties, such as salami. End users criticize their very glossy, smooth and artificial-seeming surface.

The two last-mentioned plastic casings have not been able to establish themselves as an alternative to traditional collagen or natural gut skin. In the case of the former, this is especially owing to its lack of caliber stability and its cloudiness in a second packaging. The latter was not able to establish itself on the market because of its glossy unnatural optical appearance and its low water vapor permeability which is not sufficient for many applications in the uncooked sausage sector.

It was therefore an object to provide a food casing which exhibits a particularly malt, rough and natural surface structure and also does not become cloudy in a second packaging. In addition, the water vapor permeability (WVP) should be capable of being set in a defined manner over a large range (WVP from 50 to about 1100 g/m²·d), so that the ripening behavior and the permeability for hot and cold smoke are controllable via the formulation. The casing, furthermore, is to have a sufficiently high caliber stability (σ₁₅ value greater than 8 N/mm²) and be able to be peeled from the food (which is general a sausage-meat emulsion) without defects.

It has been found that the object may be achieved by incorporating an inorganic and/or organic filler into the thermoplastic mixture. As a result, the surface of the casing receives a quality of natural appearance and it loses the unwanted glossiness. In addition, the filler increases the water storage capacity and improves the water vapor- and smoke permeability.

The present invention therefore relates to a food casing made of a thermoplastic mixture which comprises at least one aliphatic polyamide and/or copolyamide and/or at least one aliphatic and/or partly aromatic copolyamide containing glycol and/or polyglycol units, in which the mixture comprises at least one inorganic and/or organic filler, the casing having a maximum depth of roughness Rₘₐₓ, determined as specified in DIN 4768, of from 7 to 60 μm and a water vapor permeability, determined as specified in DIN 53122, of at least 50 g/m²·d.

Preferably, the casing has a water vapor permeability of from 100 to 1100 g/m²·d. It is thus especially suitable for uncooked sausage, such as air-dried salami.

The following polymers or polymer mixtures can be used for the thermoplastic mixture:
(1) an aliphatic polyamide and/or copolyamide [abbreviated: (co)polyamide]
(2) an aliphatic and/or partly aromatic copolyamide containing glycol and/or polyglycol units [abbreviated: polyether block amide]
(3) a blend of (1) and (2).

Preferred (co)polyamides of this type are nylon 6 (poly(ε-caprolactam)=homopolymer of ε-caprolactam or 6-aminohexanoic acid), nylon 66 (polyhexamethylene adipamide=copolyamide of hexamethylenediamine and adipic acid), nylon 6/66 (copolyamide of ε-caprolactam, hexamethylene-diamine and adipic acid), nylon 6/10 (poly(hexamethylene sebacamide)=copolyamide of hexamethylenediamine and sebacic acid), nylon 6/12 (poly(hexamethylene dodecanamide)=copolyamide of ε-caprolactam and \overline{ω}-aminolaurolactam) or nylon 12 (poly(ε-laurolactam)=homopolymer of laurolactam). The (co)polyamide causes especially a greater film stiffness.

The polyether block amide is preferably a block copolymer. The polyglycol blocks generally have from 5 to 20 glycol units, preferably from about 7 to 15, particularly preferably about 10 glycol units. The name glycol is taken to mean here at least divalent, aliphatic or cycloaliphatic alcohols having from 2 to 15 carbon atoms. The terminal hydroxyl groups of the polyglycol blocks can be replaced by amino groups. Such block copolymers are available, for example, under the name ®Jeffamine.

The polyglycol part of the aliphatic or partly aromatic copolyamide can also have ester segments. These consist of units of at least one bifunctional aliphatic alcohol, preferably ethylene glycol or 1,2-propylene glycol (=propane-1,2-diol), and units of at least one divalent aliphatic cycloaliphatic or aromatic dicarboxylic acid, preferably adipic acid, sebacic acid or isophthalic acid.

The glycol- or polyglycol-modified copolyamide therefore in a preferred embodiment contains
a) at least one amide part having units
   a1) of at least bifunctional aliphatic and/or cycloaliphatic amines (especially hexamethylenediamine or isophoronediamine) and of at least bifunctional aliphatic and/or cycloaliphatic and/or aromatic carboxylic acids (especially adipic acid, sebacic acid, cyclohexanedicarboxylic acid, isophthalic acid ortrimellitic acid), or
   a2) of aliphatic aminocarboxylic acids, in particular \overline{ω}-amino-carboxylic acids, or lactams thereof (especially ε-caprolactam or \overline{ω}-laurolactam) or
   a3) mixtures of a1) and a2) and
b) at least one glycol or polyglycol part containing units
   b1) of an at least bifunctional aliphatic and/or cycloaliphatic alcohol having from 2 to 15 carbon atoms, in particular from 2 to 6 carbon atoms (especially ethylene glycol, propane-1,2-diol, propane-1,3-diol, butane-1,4-diol or trimethylolpropane), or
   b2) of at least one oligoglycol or polyglycol of one of the alcohols specified in b1) (especially diethylene glycol, triethylene glycol, polyethylene glycol or poly(1,2-propylene glycol)) or
   b3) of at least one aliphatic oligoglycol or polyglyco! of the type specified in b2) the terminal hydroxyl groups of which are replaced by amino groups (®Jeffamine) or
   b4) of a mixture of b1), b2) and/or b3) or
   b5) of an ester-containing polyglycol part formed from at least bifunctional aliphatic alcohols (especially ethylene glycol or 1,2-propylene glycol) and at least divalent aliphatic, cycloaliphatic and/or aromatic dicarboxylic acids (especially adipic acid, sebacic acid or isophthalic acid) or
   b6) of a mixture of b1), b2) and/or b5).

Preferably, the modified polyamide contains no further constituents in addition to those specified.

Finally, in the thermoplastic mixture, not only (co)polyamide but also polyether block amide can be present. The content of (co)polyamide is from 10 to 99% by weight, preferably from 15 to 90% by weight, and the content of polyether block amide is from 1 to 90% by weight, preferably from 10 to 85% by weight, in each case based on the total weight of said polymers in the thermoplastic mixture.

Based on the total weight of the thermoplastic mixture, (co)polyamide, polyether block amide or a mixture of both is present in an amount of from 50 to 99% by weight, preferably from 60 to 98% by weight.

The thermoplastic mixture further comprises according to the invention at least one filler, which can be of organic or inorganic origin.

As organic fillers, in particular carbohydrates can be used; these can consist of a natural polysaccharide and/or a derivative thereof. Branched and crosslinked polysaccharides and derivatives thereof are likewise suitable. Proteins can be used with restrictions, since they are to a large part broken down at the high processing temperatures.

Particularly suitable polysaccharides are, for example, plant powders, fibers, fibrids or pulps from cellulose. They should have particle sizes or fiber lengths of from 5 to 3000 μm, preferably from 10 to 1000 μm, particularly preferably from 15 to 500 μm. These include plant hairs or seed fibers such as cotton, kapok or akon, bast fibers such as flax or linen, hemp, jute, sunn, kenaf, urena, roselle or ramie, hard fibers (sisal, henequen, manila, fique, phormium, esparto grass, peat, straw, yucca), fruit fibers (coconut, pineapple, apple, orange), softwood and hardwood fibers (spruce, pine, cork flour), other plant fibers, such as Tillandsia, and also fibers from wheat, potatoes, tomatoes or carrots.

Use can also be made of native starch, for example from potatoes, manioc, Maranta (=arrowroot), sweet potato, wheat, corn, rye, rice, barley, millet, oats, sorghum, chestnuts, acorns, beans, peas, bananas, palm pith (sago). Corn starch is particularly preferred. The ratio of amylose to amylopectin in the various starches can vary. The molecular weight M_{w} is expediently from about 50 000 to 10 000 000.

Starch derivatives are, for example, grafted native starches. Grafting agents are in particular maleic anhydride, succinic anhydride or ε-caprolactone. Derivatives which are also suitable are starch esters, in particular starch xanthogenates, acetates, phosphates, sulfates, nitrate, maleates, propionates, butyrates, laurates and oleates. In addition, starch ethers, such as starch methyl ether, ethyl ether, propyl ether, butyl ether, alkenyl ether, hydroxyethyl ether, hydroxpropyl ether. Oxidized starches such as dialdehyde starch, carboxy starch or starch broken down by persulfate are likewise suitable.

In addition, crosslinked carbohydrates can be used. These are crosslinked, for example, with urea derivatives, urotropin, trioxane, di- or polyepoxides, di- or polychlorohydrins, di- or polyisocyanates, carbonic acid derivatives, diesters or inorganic polyacids, such as phosphoric acid or boric acid.

In addition the following are suitable as natural substance component: olive seed meal, xanthan, gum arabic, gum gellan, gum ghatti, gum karaya, tragacanth gum, emulsan, rhamsan, wellan, schizophyllan, poly-galactorunates, laminarin, amylose, amylopectins and also pectins. Those which can be used are also alginic acid, alginates, carrageenan, furcellaran, guar gum, agar agar, tamarind gum, aralia gum, arabinogalactan, pullulan, carob bean gum, chitosan, dextrins, 1,4-α-D-polyglucan. The molecular weight M_{w} of said carbohydrates is generally from 500 to 100 000.

It is also possible to use synthetic, high-temperature-stable fibers or powders based on fluoropolymers, polysulfones, polyethersulfones, polyether ketones, polyphenylene sulfides, polyaramides, polyimides, aromatic poly-esters, polyquinoxalines, polyquinolines, polybenzimidazoles, liquid-crystal polymers and conducting polymers. Their fiber length or particle size is generally from 5 to 3000 μm, preferably from 10 to 1000 μm, particularly preferably from 15 to 500 μm.

Substances which are likewise suitable are inorganic fillers or reinforcing materials, such as glass fibers, glass filaments, glass staple fibers, glass microbeads, mineral wool fibers, carbon fibers, zeolites, quartz, aluminum silicate hollow beads, silicon dioxide, barium sulfate, calcium sulfate and calcium carbonate, aluminum hydroxide, magnesium carbonate, titanium dioxide, talc, clay, mica.

The fillers or the fiber gives the casing a silky-matt, parchment-like natural gut-skin-like appearance. The surface receives a slight roughness which can be set via the type of filler. In addition, the ability of the casing to be formed into rings can be set via the filler content. Furthermore, the filler acts as reinforcing agent, which significantly increases the caliber stability of the filled material compared with the unfilled. Finally, fillers, in particular organic fillers, give rise to increased gas and water vapor permeability which can likewise be set via the type and quantity.

A peculiarity of collagen casings is their high water-retention capacity which contributes considerably to the good ripening behavior in the case of uncooked sausage varieties. This effect, in the case of the inventive casing, can be imitated by fillers which have a high swelling capacity and act like superabsorbents. This has a beneficial effect on the ripening behavior of uncooked sausage, and it also promotes mold growth in mold-ripened uncooked sausage. Suitable substances are, in particular, sulfate-, carboxylate- or phosphate-containing substances and those having quaternary ammonium groups. Likewise, neutral substances with high swelling capacity are suitable. The materials can be crosslinked, uncrosslinked, branched or unbranched. Substances which can be used are, for example, natural organic thickeners such as agar, alginates, pectins, carrageenans, tragacanth, gum arabic, guar seed meal, carob bean meal and gelatin, and in addition also modified organic natural substances such as (sodium)carboxymethylcellulose, sodium carboxymethylethylcellulose, methyl hydroxyethylcellulose, methyl hydroxypropylcellulose, hydroxyethylcellulose and carboxymethylstarch. In addition it is also possible to use inorganic thickeners (for example silica or polysilica), clay minerals, such as montmorillonites or zeolites. Fully synthetic thickeners which can be used are vinyl polymers, polycarboxylic acids, polyethers, polyimines and polyamides. In addition superabsorbents based on polyacrylate or polymethacrylate can be used.

The smoke permeability may likewise be set by the type and content of filler(s). The casing is suitable for cold smoking (up to 25° C.), warm smoking (25-50° C.) and hot smoking (>50° C.). The intensity of the smoke aroma and smoke color imparted to the sausage increases with increasing temperature of the smoking gas. Furthermore, the smoke, owing to its aldehydic, phenolic and acidic constituents, has a preservative, antioxidant and consolidating action.

The total content of filler is generally from 1 to 50% by weight, preferably from 1 to 35% by weight, particularly preferably from 2 to 30% by weight, in each case based on the total weight of the thermoplastic mixture. At a high filler content, the casing may be torn like paper and can curled off from the sausage-meat emulsion.

The inventive food casing preferably has a maximum roughness depth Rₘₐₓ (determined as specified in DIN 4768; E 1989) of from 10 to 50 μm, particularly preferably from 14 to 48 μm, a mean roughness Ra (determined as specified in DIN 4762; E 1989) of from 0.8 to 10 μm, preferably from 1.2 to 7 μm, particularly preferably from 1.5 to 6.5 μm, and a mean roughness depth Rz (determined as specified in DIN 4768; E 1989) of from 4 to 45 μm, preferably from 7 to 35 μm, particularly preferably from 8 to 32 μm. The roughness may be set via the content and particle size of the fillers.

The addition of a plasticizer is advisable. This simplifies processing on blown-film plants, since the material is less brittle. Furthermore, the better digestion of the filler components gives a more homogeneous film structure, which is desired for certain applications.

Preferred plasticizers are dimethyl sulfoxide (DMSO), butane-1,3-diol, glycerol, water, ethylene glycol, butylene glycol, diglyceride, diglycol ether, formamide, N-methylformamide, N,N-dimethylformamide (DMF), N,N-di-methylurea, N,N-dimethylacetamide, N-methylacetamide, poly(alkylene oxide), glycerol mono-, di-ortriacetate, sorbitol, erythritol, mannitol, gluconic acid, galacturonic acid, glucaric acid, glucuronic acid, polyhydroxycarboxylic acids, glucose, fructose, sucrose, citric acid or citric acid derivatives, or poly-(vinyl alcohol). Type and amount of plasticizer(s) depend on the fillers chosen in each case and may be optimized by simple preliminary experiments.

The content of plasticizer is up to 30% by weight, preferably up to 20% by weight, particularly preferably from 2 to 20% by weight, in each case based on the total weight of the thermoplastic mixture.

If desired, the inventive casing can be colored by dyes and/or pigments. On stretching, cavities (vacuoles) can form around the pigment particles. The vacuoles additionally increase the water vapor permeability or gas permeability of the film. The dyes or pigments are expediently added to the thermoplastic mixture before extrusion. In addition, if required, additives can be added which affect the sausage-meat emulsion adhesion. In principle, those which are suitable are nitrogenous compounds and carboxyl-group-containing compounds. Improved sausage-meat emulsion adhesion, which in particular is demanded in the case of uncooked sausage, can also be achieved by physical processes such as corona treatment.

The inventive casing may be produced free of hygienic defects in uniform quality. The production process is considerably simpler than the collagen process. Finally, the casing can be processed for end use using known processes (printing, ring-forming, shirring).

The inventive food casing may be produced generally by a blown-tube process or by biaxial orientation. In the case of the blown-tube process, the extruded tube is stretched in the peripheral direction (transverse direction) by inflation and in the longitudinal direction by take-off rolls. Since the shaping takes place immediately from the melt, the degree of orientation of the polymer chains is low. In the case of biaxial orientation, a tube of relatively high wall thickness is first produced by extrusion. This tube is inflated only a little or not at all. Then what is termed the primary tube is cooled. Not until the later step is the primary tube heated to the temperature necessary for the biaxial orientation and then biaxially orientated by an internally-acting gas pressure and by take-off rolls. By this means a high degree of orientation of the polymer chains is achieved, much higher than in the case of a blown film.

The seamless tubular casing preferably has a thickness of from 40 to 200 μm, when it is made by a blown tube process, and a thickness of from 25 to 75 μm, when it was obtained by biaxial orientation (double bubble process). Seamless tubular casings which are to be used as artificial sausage casings, are preferably produced by biaxial orientation. After the biaxial orientation, expediently there further follows a partial or complete thermosetting. By means of the thermosetting, the casing shrinkage can be set to the desired value. Artificial sausage casings generally have a shrinkage of less than 20% in the longitudinal and transverse directions if they are laid for 1 min in water at 90° C.

The inventive food casing is suitable, owing to its water vapor permeability, particularly as artificial sausage casing for uncooked sausage, such as salami.

The examples hereinafter illustrate the invention. Percentages therein are percentages by weight, unless stated otherwise, or is obvious from the context. The components specified in the examples were in each case mixed in a twin-screw extruder and thermally plasticized.

Process 1:

The organic filler was first charged into the extruder and a plasticizer was added. The temperature in the extruder was increased over a plurality of zones from about 90 to about 180° C. The (co)polyamide or the polyether block amide or a mixture of both and, if required, additives to improve the sausage-meat emulsion adhesion were then fed into the extruder, mixed with the remaining constituents at temperatures between 200 and 230° C. and the thermoplastic melt formed therefrom was extruded. The extrudate was finally comminuted to form granules.

Process 2:

In this case first the (co)polyamide or the polyether block amide or the mixture of both, and if required additives to improve the sausage-meat emulsion adhesion, were fed into the extruder and mixed at temperatures between 200 and 230° C. Thereafter, the organic or inorganic filler was added. A plasticizer is not absolutely required in this case. The thermoplastic mixture was finally comminuted to form granules. The granules were then processed on a blown-film plant at about 190 to 230° C. to form a tubular film.

In the examples the following were used:
nylon 6/66-poly(ethylene glycol) block copolymer containing ester intermediate groups (®Grilon FE 7012 from Ems Chemie AG)
nylon 6-poly(ethylene glycol) block copolymer (®Pebax MH 1657 from Elf Atochem S.A.)
nylon 12-poly(ethylene glycol) block copolymer (®Pebax MV 1074 SA from Elf Atochem S.A.)
nylon 6/66 (®Ultramid C4 from BASF Aktiengesellschaft)
nylon 6 (®Grilon F40 from Ems Chemie AG)

Compositions and properties of the tubular casings according to examples 1 to 14 are summarized in tables 2 and 3.

TABLE 1

| 1 | Thermoplastic mixture | 2 | Filler | 3 | Plasticizer |
|---|---|---|---|---|---|
| a) | (co)polyamide | | Polysaccharide or | | Plasticizer |
| | for stability and sausage-meat | | inorganic filler | | |
| | emulsion adhesion | | | | |
| b) | glycol- or polyglycol-modified | | natural feel properties/ | | |
| | polyamide | | optical properties | | |
| | for water vapor- and | | curling ability | | suppleness |
| | smoke permeability | | | | |
| c) | blend of (co)polyamide and glycol- or | | water vapor- and | | digestion of the |
| | polyglycol-modified polyamide | | smoke permeability | | natural material |
| | for stability, sausage-meat | | control of the | | |
| | emulsion adhesion, water | | water-retention | | |
| | vapor- and smoke permeability | | capacity | | |

The following 6 raw material combinations are conceivable: [1](a) + [2] // [1](b) + [2] // [1](c) + [2] //[1](a) + [2] + [3] // [1](b) + [2] + [3] // [1](c) + [2] + [3]

TABLE 2

| | Thermoplastic mixture | | Filler | | Plasticizer | | |
|---|---|---|---|---|---|---|---|
| Example | % by | | % by | | % by | | |
| No. | weight | | weight | | weight | | Process |
| 1 | 65 | Grilon F 40 | 25 | Corn starch | 10 | Glycerol | 1 |
| 2 | 92 | Grilon F 40 | 8 | Corn starch | — | — | 2 |
| 3 | 45 | Grilon FE 7012 | 10 | Cellulose powder | — | — | 2 |
| | 45 | Ultramid C4 | | | | | |
| 4 | 38 | Grilon FE 7012 | 9 | Corn starch | 6 | Glycerol | 1 |
| | 38 | Ultramid C4 | 9 | Guar seed meal | | | |
| 5 | 74 | Grilon FE 7012 | 15 | Corn starch | 11 | Glycerol | 1 |
| 6 | 65 | Grilon FE 7012 | 20 | Corn starch | 15 | Glycerol | 1 |
| 7 | 39 | Pebax MH 1657 | 12 | Glass microbeads | — | — | 2 |
| | 49 | Grilon F 40 | | | | | |
| 8 | 12 | Pebax MH 1657 | 9 | Cellulose powder | 6 | Glycerol | 1 |
| | 73 | Ultramid C4 | | | | | |
| 9 | 42 | Pebax MH 1657 SA | 10 | Corn starch | 6 | Glycerol | 1 |
| | 35 | Ultramid C4 | | | | | |
| 10 | 35 | Pebax MH 1657 SA | 21 | Corn starch | 9 | Glycerol | 1 |
| | 35 | Ultramid C4 | | | | | |
| 11 | 27 | Pebax MH 1657 SA | 21 | Corn starch | 8 | Glycerol | 1 |
| | 44 | Ultramid C4 | | | | | |
| 12 | 18 | Pebax MV 1074 SA | 20 | Corn starch | 8 | Glycerol | 1 |
| | 54 | Grilamid L25 | | | | | |
| 13 | 52 | Grilon FE 7012 | 20 | Corn starch | 8 | Glycerol | 1 |
| | 20 | Ultramid C4 | | | | | |
| 14 | 68 | Grilon FE 7012 | 10 | Corn starch | 6 | Glycerol | 1 |
| | 16 | Ultramid C4 | | | | | |

TABLE 3

| | | | | Elongation | | | | |
|---|---|---|---|---|---|---|---|---|
| | | σ₁₅ value)² | Tear strength)² | at break)² | | | | |
| | WVP)¹ | longitudinal/ | longitudinal/ | longitudinal/ | Swelling | Roughness | | Film |
| | (g/m²d) | transverse | transverse | transverse | value | Rₐ/R_{z}/Rₘₐₓ | Glossiness | thickness |
| Example | [g/m²] | [N/mm²] | [N/mm²] | [%] | [%] | [μm] | 20°/60°/85° | [μm] |
| 1 | 110 | 23.0/19.0 | 44/33 | 391/258 | 50 | — | — | 64 |
| 2 | 60 | 30.0/28.0 | 50/45 | 200/180 | 40 | — | — | 55 |
| 3 | 154 | 11.0/8.0 | 17/7 | 133/30 | 55 | 6.3/31/39 | 0.6/6.8/4.4 | 100 |
| 4 | 231 | 12.0/10.0 | 24/14 | 282/264 | 70 | 5.5/28/48 | 0.5/6.5/4.8 | 112 |
| 5 | 552 | 12.0/15.1 | 25/25 | 616/560 | 49 | 1.5/8/14 | 0.4/5.7/0.9 | 60 |
| 6 | 826 | 11.5/8.1 | 22/13 | 587/330 | 52 | 2/10/14 | 0.2/2.6/3.8 | 60 |
| 7 | 821 | 12.0/9.0 | 23/14 | 299/105 | 50 | 2.6/14/26 | 1.2/11.4/18.7 | 72 |
| 8 | 116 | 15.0/13.0 | 34/33 | 403/382 | 60 | 4.0/22/26 | 0.5/6.0/4.2 | 98 |
| 9 | 1005 | 10.0/8.0 | 24/20 | 429/413 | — | — | — | 100 |
| 10 | 1003 | 8.0/8.0 | 18/17 | 391/376 | — | — | — | 100 |
| 11 | 400 | 12.0/11.8 | 32/30 | 310/300 | — | — | — | 100 |
| 12 | 170 | 17.0/18.0 | 36/33 | 380/360 | — | — | — | 60 |
| 13 | 600 | 13.0/14.0 | 24/22 | 450/440 | — | — | — | 60 |
| 14 | 400 | 16.5/17.5 | 35/34 | 550/540 | — | — | — | 60 |

)¹WVP = water vapor permeability. The casing was charged at one end with air of a relative humidity of 85% at 23° C.; the water vapor permeability was determined as specified in DIN 53 122.
)²as specified in DIN 53 455 determined on dry samples of width 15 mm at a clamped length of 50 mm

### COMPARATIVE EXAMPLE 1 (EP-A 1 102 814)

As described in the examples above, a tubularfilm was produced from a thermoplastic mixture of the type specified in EP-A 1 102 814. The mixture specifically contained the following:
42% by weight of thermoplastic polyesterurethane (as described in EP-A 1 102 814)
35% by weight of corn starch
23% by weight of glycerol

The finished film had a thickness of 120 μm. Its σ₁₅ value was 4.2 N/mm² and its water vapor permeability was 200 g/m²·d. The roughness parameters Rₐ/R_{z}/Rₘₐₓ were 0.3/1.8/2.4 μm.

Despite a higher thickness, this film had a lower mechanical stability (recognizable from the sigma-15 value) than that of the inventive film. In addition, the roughness of the casing was markedly less.

### COMPARATIVE EXAMPLE 2 (EP-A 935 423)

As described above, a tubular film was produced from a thermoplastic mixture of the following composition:
38% by weight of Grilon F40
27 % by weight of Ultramid C4
35 % by weight of Grilon FE 7012

The finished film had a thickness of 25 μm and a water vapor permeability of 75 g/m²·d. The roughness parameters Rₐ/R_{z}/Rₘₐₓ were 0.5/3.0/3.7 and the glossiness at 20°/60°/85° was 13.5/82.1/87.6. The inventive film, in contrast, had a markedly higher water vapor permeability, a glossiness lower by some orders of magnitude and a more natural roughness.

1. A food casing made of a thermoplastic mixture which comprises at least one aliphatic polyamide and/or copolyamide and/or at least one aliphatic and/or partly aromatic copolyamide containing glycol and/or polyglycol units, wherein the mixture comprises at least one inorganic and/or organic filler, the casing having a maximum depth of roughness Rₘₐₓ, of from 7 to 60 μm and a water vapor permeability, of at least 50 g/m²·d.

2. The food casing as claimed in claim 1, wherein it has a water vapor permeability of from 100 to 1100 g/m²·d.

3. The food casing as claimed in claim 1, wherein the (co)polyamide is nylon 6, nylon 66, nylon 6/66, nylon 6/10, nylon 6/12 or nylon 12.

4. The food casing as claimed in claim 1, wherein the aliphatic and/or partly aromatic copolyamide containing glycol and/or polyglycol units has
a) at least one amide part having units
a1) of at least bifinctional aliphatic and/or cycloaliphatic amines and of at least bifunctional aliphatic and/or cycloaliphatic and/or aromatic carboxylic acids, or
a2) of aliphatic aminocarboxylic acids or lactams thereof or
a3) mixtures of a1) and a2) and
b) at least one glycol or polyglycol part containing units
b1) of an at least bifunctional aliphatic and/or cycloaliphatic alcohol having from 2 to 15 carbon atoms, in particular from 2 to 6 carbon atoms, or
b2) of at least one oligoglycol or polyglycol of one of the alcohols specified in b1) or
b3) of at least one aliphatic oligoglycol or polyglycol of the type specified in b2) the terminal hydroxyl groups of which are replaced by amino groups or
b4) of a mixture of b1), b2) and/or b3) or
b5) of an ester-containing polyglycol part formed from at least bifunctional aliphatic alcohols and at least divalent aliphatic, cycloaliphatic and/or aromatic dicarboxylic acids or
b6) of a mixture of b1), b2) and/or b5).

5. The food casing as claimed in claim 1, wherein the thermoplastic mixture comprises a mixture of (co)polyamide and polyether block amide, the content of (co)polyamide being from 10 to 99% by weight, and the content of polyether block amide being from 1 to 90% by weight, in each case based on the total weight of said polymers in the thermoplastic mixture.

6. The food casing as claimed in claim 1, wherein the content of the (co)polyamide, the polyether block amide or the mixture of both is in general from 50 to 99% by weight, based on the total weight of the thermoplastic mixture.

7. The food casing as claimed in claim 1, wherein the organic filler is a carbohydrate, and/or a derivative thereof, a branched or crosslinked polysaccharide and/or a derivative thereof.

8. The food casing as claimed in claim 1, wherein the inorganic filler consists of glass fibers, glass filaments, glass staple fibers, glass microbeads, mineral wool fibers, carbon fibers, zeolites, quartz, aluminum silicate hollow beads, silicon dioxide, barium sulfate, calcium sulfate, calcium carbonate, aluminum hydroxide, magnesium carbonate, titanium dioxide, talc, clay and/or mica.

9. The food casing as claimed in claim 1, wherein the filler is highly swellable substance or a substance comprising quaternary ammonium salts or an organic thickener, a modified organic natural substance, an inorganic thickener, a fully synthetic thickener or a super-absorbent based on polyacrylate or polymethacrylate.

10. The food casing as claimed in claims 1, wherein the content of the filler is from 1 to 50% by weight, based on the total weight of the thermoplastic mixture.

11. The food casing as claimed in claim 1, wherein its surface has a maximum roughness depth Rₘₐₓ of from 10 to 50 μm, a mean roughness parameter Ra of from 0.8 to 10 μm, and a mean roughness depth Rz of from 4 to 45 μm.

12. The food casing as claimed in claim 1, wherein it additionally comprises a plasticizer.

13. The food casing as claimed in claim 12, wherein the content of plasticizer is up to 30% by weight, based on the total weight of the thermoplastic mixture.

14. A process for producing a food casing as claimed in claim 1, which comprises blow-forming or biaxially orienting the tube produced from the thermoplastic mixture by extrusion.

15. (canceled)

16. The food casing as claimed in claim 5, wherein the content of (co)polyamide being from 15 to 90% by weight, and the content of polyether block amide being from 10 to 85% by weight, in each case based on the total weight of said polymers in the thermoplastic mixture.

17. The food casing as claimed in claim 6, wherein the content of the (co)polyamide, the polyether block amide or the mixture of both is from 60 to 98% by weight, in each case based on the total weight of the thermoplastic mixture.

18. The food casing as claimed in claim 7, wherein the carbohydrate is a natural polysaccharide and/or a derivative thereof.

19. The food casing as claimed in claim 9, wherein the highly swellable filler is a sulfate-, carboxylate- or phosphate-containing substance.

20. The food casing as claimed in claim 10, wherein the content of the filler is from 2 to 30% by weight, based on the total weight of the thermoplastic mixture.

21. The food casing as claimed in claim 12, wherein the plasticizer is dimethyl sulfoxide, butane-1,3-diol, glycerol, water, ethylene glycol, butylene glycol, diglyceride, diglycol ether, formamide, N-methylformamide, N,N-dimethylformamide, N,N-dimethylurea, N,N-dimethylacetamide, N-methylacetamide, poly(alkylene oxide), glycerol mono-, di- or triacetate, sorbitol, erythritol, mannitol, gluconic acid, galacturonic acid, glucaric acid, glucuronic acid, polyhydroxycarboxylic acids, glucose, fructose, sucrose, citric acid, citric acid derivatives, or poly(vinyl alcohol).

22. The food casing as claimed in claim 13, wherein the content of plasticizer is from 2 to 20% by weight, based on the total weight of the thermoplastic mixture.
